(19) United States
(12) Patent Application Publication
(10) Pub. No.: US 2010/0063697 A1
(43) Pub. Date: Mar. 11, 2010

(54) METHOD FOR ADAPTING AN AUTOMATIC MECHANICAL TRANSMISSION ON A HEAVY VEHICLE

(75) Inventors: Anders Lindgren, Hisings Karra (SE); Anders Eriksson, Torslanda (SE); Bo Hammerlid, Greensboro, NC (US); Mats Henrik Tobiasson, Goteborg (SE); Sixten Berglund, Torslanda (SE)

Correspondence Address: WRB-IP LLP, 1217 KING STREET, ALEXANDRIA, VA, 22314, US

(73) Assignee: Volvo Lastvagnar AB, Goteborg (SE)

(21) Appl. No.: 12/441,388

(22) PCT Filed: Sep. 13, 2007
(86) PCT No.: PCT/SE07/00801

§ 371 Date: Sep. 10, 2009

Related U.S. Application Data
(60) Provisional application No. 60/825,859, filed on Sep. 15, 2006.

(51) Int. Cl. B60W 50/08; B60W 30/18

(52) U.S. Cl. 701/59

(57) ABSTRACT

System and method for adapting an automatic mechanical transmission (AMT) on a heavy vehicle. The method includes assessing at least one driving characteristic of an operator of the vehicle. Specific examples are detailed below, but in general these will be driving traits that demonstrate the driver's proficiency at executing certain driving tasks. This is taken as a predictor of his or her ability to handle and properly use advanced vehicle features that are beneficial when used properly, but that typically also have a capacity for misuse. Based on the assessment, the operator is classified as being either entitled to enhanced transmission features or not entitled to enhanced transmission features. If the classification is positive, that is the driver is classified as being entitled to enhanced transmission features; at least one enhanced transmission feature is enabled for the operator.

### BACKGROUND AND SUMMARY OF THE INVENTION

The present invention generally relates to a method for adapting control strategies for an automatic mechanical transmission in light of predetermined criteria associated with driver performance.

The present invention also relates to a computer program and computer program product both to be used with a computer for executing said method.

Heavy commercial vehicles such as overland trucks and buses are known to employ automatic mechanical transmissions (AMTs) that are based on preprogrammed routines. These transmissions generally have been arranged to provide uniform characteristics based upon the preprogrammed routines. Engines have been controlled by electronic controls for a number of years as well, hi an effort to encourage good or optimal driving habits, specially designed engine reward features have been implemented in the electronic controller of the engine. Thus, a driver who operates the engine in prescribed, optimal ways, such as driving with a “gentle foot” and thereby achieving high-economy travel, might be rewarded with increased horsepower availability from the engine control unit because it is assumed that he/she will only use it when actually needed based on his analyzed driving history. An example of such engine rewards are disclosed in U.S. Pat. No. 6,366,848, which is hereby incorporated by reference in its entirety.

The present disclosure recognizes the desirability of implementing a similar system of enabling additional transmission features when a controller of the vehicle determines that a particular driver has proven himself/herself worthy by driving in an optimal way.

In at least one embodiment, the invention takes the form of a method for adapting an automatic mechanical transmission (AMT) on a heavy vehicle. The method includes assessing at least one driving characteristic of an operator of the vehicle. Specific examples are detailed below, but in general these will be driving traits that demonstrate the driver's proficiency at executing certain driving tasks. This is taken as a predictor of his or her ability to handle and properly use advanced vehicle features that are beneficial when used properly, but that typically also have a capacity for misuse. Based on the assessment, the operator is classified as being either entitled to enhanced transmission features or not entitled to enhanced transmission features. If the classification is positive, that is the driver is classified as being entitled to enhanced transmission features, at least one enhanced transmission feature is enabled for the operator.

Alternatively, the current transmission features are maintained for the operator if he or she is classified as not being entitled to enhanced transmission features. Still further, instead of maintaining the status quo, the invention also contemplates a reduction in the current transmission features if the operator is classified as not being entitled to enhanced transmission features, or if the assessment determines the operator to have sub-par driving characteristics.

In one embodiment, the driving characteristics of the operator of the vehicle that might be assessed for proficiency include one or more of the following: (a) switching between brake and accelerator actuation; (b) clutch utilization; (c) accelerator utilization; (d) cruise control utilization; (e) engine warm-up utilization; (f) engine cool-down utilization; and (g) affecting regeneration of a regenerative diesel particulate filter.

In another embodiment, the judged characteristics are measurable, transmission-related characteristic of the operator of the vehicle. They can include at least one of the following: (a) proficiency of operator selection of economy mode driving; (b) proficiency of operator selection of free-wheeling mode driving; (c) proficiency of start gear selection; and (d) proficiency of operator utilization of braking programs.

Examples of enhanced transmission features that can be enabled include: (a) kickdown; (b) skip shifting; (c) manual mode shifting; (d) auxiliary brake enabled mode; (e) free-wheeling mode; (f) idle driving; and (g) bump-shifting in idle drive mode.

As a further development, vehicle engine capabilities may also be enhanced based on an assessment of the operator's driving characteristics; examples of such engine enhancements include: (a) increased maximum horsepower output; (b) increased maximum torque output; (c) increased maximum engine speed; and (d) enhanced engine responsiveness.

### BRIEF DESCRIPTION OF THE DRAWINGS

The accompanying drawings variously illustrate aspects of the presently disclosed inventions. It should be appreciated that the illustrated embodiments are exemplary only, and do not serve as limitations to the protection. The drawings do, however, constitute part of the disclosure of the specification, and thereby contribute to, and provide support for the patented invention(s). In the figures:

FIG. 1 is a flow chart illustrating an exemplary method for affecting an AMT-based, driver reward system;

FIG. 2A is a schematic illustration showing the different driver characteristics that might be evaluated;

FIG. 2B is a schematic illustration of the transmission features that might be enabled; and

FIG. 2C is a schematic illustration of the enhanced engine features that might be enabled.

FIG. 3 shows the invention applied on a computer arrangement.

### DETAILED DESCRIPTION OF THE INVENTION

The presently disclosed invention relates to modifying certain performance related characteristics of an AMT when evaluated driving habits indicate that the driver has an appropriate level of skill and has otherwise been driving responsibly, or at least as prescribed in the programmed criteria. Generally, this process can be thought of as a rewards process or system in which a driver exhibiting certain driving attributes is rewarded for positively viewed behavior by the enablement of additional transmission features via the program routines of the AMT's controller. Conversely, if the evaluated driving behavior indicates that the driver is underperforming, or otherwise has bad driving habits, the availability of certain features may be removed from the standard program routines.

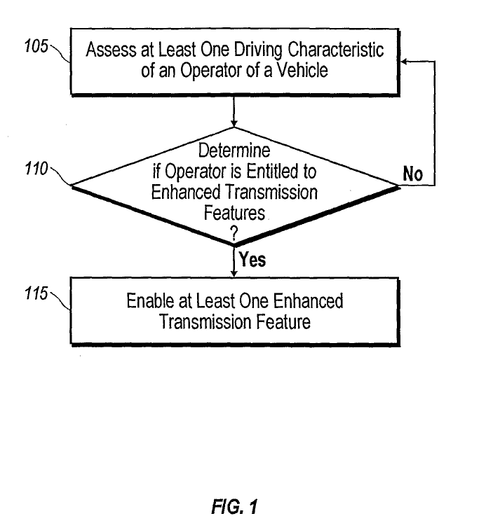

As shown in FIG. 1, the method for awarding enhanced transmission features is illustrated in a flow chart. An assessment of at least one driving characteristic of an operator of the vehicle is made (block 105). Then, a determination is made whether the operator is entitled to at least one enhanced transmission feature (block 110). If the operator is entitled to at least one enhanced transmission feature at least one enhanced transmission feature is enabled (block 115). If it is determined that the operator is not so entitled, the assessment of the at least one driving characteristic continues (block 105).

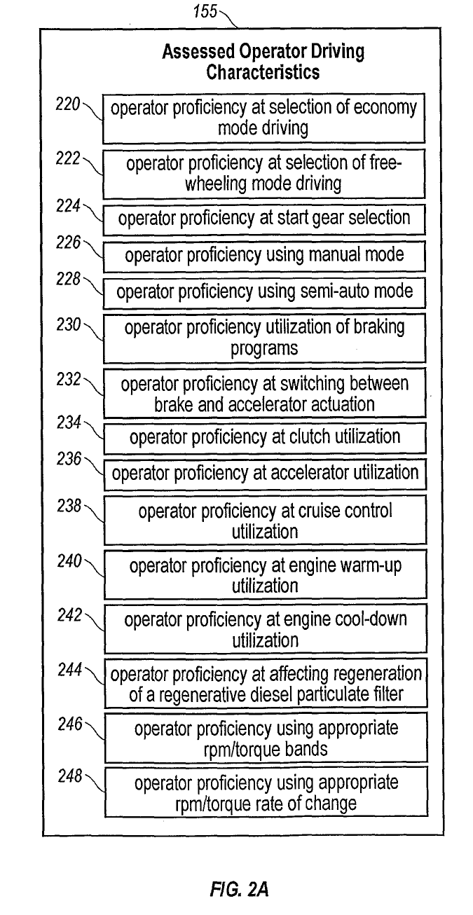

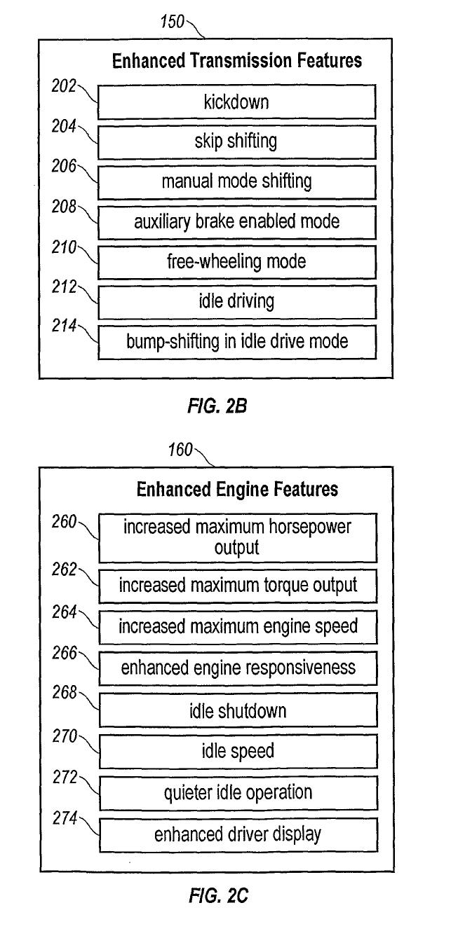

As illustrated by FIG. 2A, numerous assessed operator driving characteristics (block 155) are presented herein. While these driving characteristics are ones that are currently considered, others can be used without departing from the spirit of the invention herein. Enhanced transmission features (block 150) as well as enhanced engine features (block 160) are also presented in a list format, as shown in FIGS. 2B and 2C respectively. Likewise, these are presented as examples of some of the possible features that can be enabled upon meeting at least one of the assessed operator driving characteristics (block 155).

In a preferred embodiment, the criteria used to determine whether the driver is properly operating the vehicle involves using predetermined transmission measured characteristics. While the description below presents examples of transmission measured characteristics, others are known and will be readily appreciated by those of ordinary skill in the art.

As shown in FIG. 2 A, some examples indicating proper or optimal driver performance are the amount of time spent in “economy mode” (block 220), the use of a freewheeling mode of operation (block 222), proper start gear selection (block 224), economical use of “manual mode” (block 226), proficient use of “semi-auto” mode (block 228) and optimal use of braking programs (block 230).

As skilled persons will appreciated, a common option on AMTs is the provision of an economy mode selector switch, usually on the gear shift lever itself. This switch is activated by the driver when the driver desires that the transmission operate according to predetermined routines optimized to produce economical operation of the vehicle. A generally accepted good driving habit is to engage economy mode when driving under normal circumstances that do not require high performance features or other special modes of operation of the transmission. Normally, this entails driving in higher gears, and possibly with direct-drive engaged. Accordingly, the transmission control unit, or some other controller in communication therewith, can track the proportion of time that the driver spends in economy mode when it would have been advantageous according to programmed criteria. The tracking of the time spent in economy mode can be on an absolute basis, or tracked as a percentage of total run time of the vehicle; most advantageously, however, it will be judged against the amount of time the controller(s) determine that economy mode driving would have been appropriate under existing circumstances. Thus, it is possible to assess operator proficiency at selection of economy mode driving (block 220).

Another example of a good driving habit is the proficient use of a free-wheeling function. In order to increase efficiency, a free-wheel mode may be enabled in the programmed transmission routines such that under prescribed circumstances, the vehicle is allowed to roll without being impeded by engine resistance. The details of a free-wheeling routine are described in further detail in U.S. application Ser. No. 10/709,384 filed Apr. 30, 2004, now U.S. patent (corresponding to WO03/037672), which is hereby incorporated by reference in its entirety. Special attention is drawn to paragraphs 20-89 where details of free-wheeling functions are provided. Other examples of free-wheeling mode are described in U.S. Pat. No. 6,869,377, WO 02/092378, WO 03/037672 and WO 2005/084995, all of which are expressly incorporated by reference in their entirety. As explained above, the freewheeling function, when properly affected, produces more fuel efficient operation of the vehicle compared to operation without such a free-wheel function. Exemplary circumstances in which free-wheeling might be beneficial include when traveling on a slight to moderate downhill slope and when the vehicle is slowing, but neither the service brakes nor the auxiliary brakes of the vehicle are required (a coasting stop).

The free-wheeling function can be obtained by disengaging a synchronized split gear or disengaging a synchronized gear where there is no split gear in the gearbox. The controller deciding to engage a free-wheel function preferably receives signals from one or more of the gear shifter, accelerator pedal depression sensor, auxiliary brake control, brake pedal position sensor and cruise control module. If the conditions of the preprogrammed routine are met, then the free-wheel function is engaged. Like the time spent in economy mode, the time spent in free-wheeling mode can either be on an absolute basis or a percent basis. Furthermore, since free-wheel mode is only available in a limited number of circumstances, the time that the transmission actually enters such free-wheel mode, as compared to the circumstance in which free-wheel mode is available, is also possible for a comparison value. The use of free-wheel mode is desirable because it reduces stress on the engine and transmission, as well as saves fuel.

In another aspect, the proficiency with which a driver transitions from the freewheel mode to throttle application or engine brake application can also be used to judge the driver's eligibility profile, as regards his/her ability and responsibility for handling enhanced transmission characteristics having both beneficial, as well as possibly detrimental effects, for enhanced transmission features. In this regard, it is appreciated that the use of the freewheeling mode can be inappropriate when shortly after activation of the free-wheel mode the service brakes are activated. The number of times these appropriate and inappropriate behaviors occur can be tracked to later decide whether the use of the free-wheeling function satisfies programmed thresholds. Thus, it is possible to assess operator proficiency at selection of free-wheeling mode driving (block 222).

Yet another example of good driving habits is when the driver selects the proper starting gear for the vehicle. When starting a vehicle using an automatic mechanical transmission, the driver can select a starting gear. The selection of the starting gear by the driver may allow the transmission to skip gears that are not needed upon start up, such as in the case of a light load or when the truck does not have a trailer connected to it. This prevents the transmission from having to cycle through the low gears very rapidly. Furthermore, the driver may select a low gear in the case where the vehicle has a very heavy load. By selecting a low gear, the driver allows the vehicle to start without lugging the engine or potentially even stalling it. The transmission controller and/or engine controller can monitor the appropriate use of the start gear selection as well as the appropriateness of the particular gear selected. Likewise, when the driver inappropriately selects the start gear, a record of such occurrences can also be made. This typically happens when the driver selects a start gear that is above the appropriate start gear. Such a choice can cause the transmission to downshift, or even stall the engine in some cases. Thus, it is possible to assess operator proficiency at start gear selection (block 224).

The use of the manual mode feature of an automatic mechanical transmission also requires proficiency on the driver's part. The manual mode allows the driver to manually select upshifts and downshifts using the gear selector in the cab of the heavy vehicle. Using a manual mode to upshift as the heavy vehicle is about to crest a hill can be interpreted as a sign that the driver is using the manual mode to skillfully and efficiently shift the transmission. However, the driver can also exhibit poor driving habits with respect to such manual shifting routines by engaging a single gear and running the engine for a substantial amount of time in that gear across a wide range of engine speeds. This later use of manual mode can be harmful to both the engine and transmission, and is almost always inefficient from a fuel utilization perspective, and is therefore advantageously discouraged. Thus, it is possible to assess operator proficiency at using manual mode (block 226).

Additionally, when the driver is cresting a hill, the request by the driver to upshift may be made premature and the transmission will have to downshift before passing the crest. This request can be implemented by the driver depressing a switch on the side of the gear selector lever to indicate that an upshift should be performed while otherwise maintaining automatic control over gear selection. The number of times the driver makes an incorrect manual shift can be tracked or it can be tracked on a percentage basis such that the percentage of times the driver makes an incorrect request are tracked based on comparison to the total number of such requests made. Thus, it is possible to assess operator proficiency at using semi-auto mode (block 228).

Usually, a heavy vehicle is equipped with an auxiliary brake system to aid the driver in slowing the vehicle. In some cases the auxiliary brake is activated through an auxiliary brake control that can be adjusted to various positions, hi one possible embodiment of the present invention, the auxiliary brake control 51 can be maneuvered to a plurality of positions, for example “A”, “1”, “2”, “3” and “B”.

Position “A” corresponds to an automatic auxiliary braking mode that is controlled by a control unit if the vehicle is driven under the influence of a cruise control system. This means that the auxiliary brake is controlled with regard to a pre-set speed, with the auxiliary brakes generally being used to an increased extent the higher the speed is relative to a pre-set speed. If the vehicle is not driven by means of the cruise control, the auxiliary brake will be regulated depending on how far the brake pedal is pressed. Furthermore, position “1” corresponds to auxiliary braking with only a part of the brake torque available from the auxiliary braking functions, for example 15%. Position “2” can correspond to auxiliary braking with a slightly larger part of the braking torque available, for example 40%, while position “3” can correspond to auxiliary braking with all available braking torque (100%) from the auxiliary braking functions. The “OFF” position means that no auxiliary brake function is activated. Position “B” is used to activate a special gear selection program which selects gears so that an optimal engine braking effect is obtained. When the brake control is moved to the “B” position, the transmission can detect this because it is requested to perform special routines. The driver can misuse these routines by engaging the control to the “B” position and then switch back to depressing the accelerator pedal. This causes increased stress and wear on the transmission as well as the auxiliary brake system. Thus, it is possible to assess operator proficiency utilization of braking programs (block 230).

Additionally, the transmission can measure characteristics that are indicative of improper driving habits including the number of times the driver switches directly from the accelerator pedal to the brake pedal, the number of times the driver switches directly from the brake pedal to the accelerator pedal, each of which can result in overheating and/or overloading the clutch. Thus, an assessment as to the operator proficiency at switching between the brake and accelerator actuation can be made (block 232). The transmission controller is capable of measuring when the driver has caused the clutch to overheat or slip longer than a predetermined amount of time, thus suggesting operator proficiency at clutch utilization (block 234). When this occurs the transmission records this improper behavior for use in later determinations.

Also listed in the block entitled assessed operator driving characters (block 155) are engine measured characteristics can be used to determine whether additional transmission-based features should be enabled. One example of an engine measured characteristic is the depression of the accelerator pedal (degree and/or rate), which can also be described as operator proficiency at accelerator utilization (block 236). A driver can use the accelerator pedal aggressively by depressing the pedal rapidly as well as depressing the pedal to a greater extent than is necessary to bring the vehicle to the desired speed. Thus, it is possible to measure how fast the pedal is depressed along with the extent to which it is depressed. Furthermore, this can lead to changes in the engine speed as well as changes in the torque being produced by the engine. Maximum engine speed can be monitored, as can the time spent operating in a given band of engine speeds. For example, the engine speed bands could be set up along the lines of fifty rotations per minute (50 rpm) or 100 rpm, depending on the desired classification. Thus, the time spent in each of these bands could be detected and compared to desired operating conditions allowing operator proficiency using appropriate rpm/torque bands to be assessed (block 246).

The torque requested from the engine can also be monitored for both maximum torque requested, as well as the time in which requested torque is produced within a particular band. Furthermore, the rate of change in the engine speed and torque produced by the engine can be monitored. Rate of change refers to the change in engine speed over a period of time. For example, if the engine speed increases from 900 rpm to 1200 rpm in a period of three seconds (3 s) the rate of change would be 100 rpm/s. Thus, operator proficiency at using appropriate rpm/torque rate of change can be assessed (block 248). Additionally, the engine controller can monitor the use of the cruise control system. The use of cruise control allows the driver to maintain a substantially constant road speed. The frequency of use of the cruise control along with the set road speed value can be stored and monitored. Thus, operator proficiency at cruise control utilization can be assessed (block 238).

Furthermore, the controllers) can monitor particular good/bad uses of the engine such as whether sufficient warm up (block 240) and cool down (block 242) is provided, or how the engine is used in conjunction with regenerative diesel particulate filter cleaning processes (block 244). When starting up the engine of a heavy vehicle, it is desirable to allow the engine to obtain a prescribed operating temperature before driving it down the road or subjecting the engine to high engine speeds or high engine loads. In a like manner, once the engine has been run under heavy load conditions such as uphill driving, it is desirable to cool the engine down before switching it off. Thus, it is possible to monitor the time spent warming the engine up before initiating heavy loads and high speeds and the time spent cooling it off before shutdown. Implementation includes monitoring engine temperature when a particular engine speed or torque value has been exceeded for a predetermined period, as well as monitoring engine temperature at shut down. These can be compared to optimal or desired parameters to determine if the driver has appropriately allowed the engine to warm up or cool down. Thus, operator proficiency at engine warm-up utilization (block 240) and engine cool-down utilization (block 242) can be obtained.

When a heavy vehicle is equipped with a regenerative diesel particulate filter, the regeneration can occur either during normal driving operation or through special operation of the engine to produce the regenerative effect. The number of times the filter is regenerated through normal driving operation and the number of times special operation of the engine is required can be monitored. This number can additionally be measured in terms of the percentage each is used in relation to the number of regenerative cycles performed or the ratio of special operation compared to normal operation or vice versa. Thus, it is possible to assess operator proficiency at affecting regeneration of a regenerative diesel particulate filter (block 244).

Examples of possible enhanced transmission features (block 150) are shown in FIG. 2B. According to the present invention, when certain indicators have been identified signifying the driver as being of sufficient quality to warrant the extension of enhanced transmission characteristics, those added features, among others, can include: kickdown (block 202), skip shifting (block 204) including increasing the number gears that can be skip shifted, manual mode activation where previously turned off (block 206) including enablement of specific buttons on the gear selector, special auxiliary brake mode (block 208), a free-wheeling mode (block 210) including increased overspeed limit while in free-wheeling operation, idle driving mode (block 212) and bump-shifting in idle drive mode (block 214).

The kickdown feature (block 202) of the transmission is a specially designed routine to provide maximum acceleration to the vehicle when the accelerator pedal is fully depressed. This can include a specialized gear selection routine, gear shifting routine, and engine fueling routine.

A skip shifting routine (block 204) allows the driver or transmission control routine to skip over a number of intervening gears between the currently selected gear and the desired gear. For instance, if a truck is operating with a light load and is currently in gear 8, it is possible under appropriate driving conditions to move directly to gear 12. If performed using a manual transmission, the driver would select gear 12 by hand. However, typical AMTs must engage each successive gear before proceeding to the next gear. Some AMTs allow for skip shifting to take place such that two gears could be skipped and in the above described instance gear 11 engaged. Then a single shift would take place to bring the transmission into the desired gear 12. Alternatively, the skip shifting routine (block 204) of the transmission could allow for skipping all of the gears between 8 and 12 and engaging gear 12 directly. Other skip shift limitations can be implemented as well. In some embodiments, the skip shifting feature (block 204) might initially be disabled and upon exhibition of some of the above described characteristics indicating driving proficiency, the skip shifting feature (block 204) is enabled. Additionally, once the skip shifting feature (block 204) is enabled, it might be possible to only allow a certain number of gears to be skipped until some of the above criteria had been met. Still further, it is contemplated that the enablement can be stepwise; that is, as higher driving proficiency is assessed, higher numbers of gear-skips are enabled.

The transmission might be further enabled to implement a specially designed routine for gear selection and shifting associated with the auxiliary brake system (block 208). As previously described, the auxiliary brake control can be designed such that a “B” mode can be engaged such that the transmission will be specifically adapted to allow for added braking power. This mode can be initially disabled and only enabled once the driver meets a set of predetermined criteria using the above defined measured criteria.

The manual mode of operation of the transmission (block 206) allows the driver to manually control the engagement of the gears of the transmission. The engagement of the gears by the driver can lead to the problem cited above in relation to the manual selection of the gears. Thus, in some cases, the manual mode (block 206) may be initially restricted and then only later added once a set of predetermined criteria have been met. Likewise, the buttons that enable the driver to select a particular gear change, typically buttons indicating “+” and “−”, can initially be disabled while in automatic mode and later enabled if a set of predetermined criteria are met by the driver.

Regarding the free-wheeling mode (block 210); as previously described, this feature (block 210) enables the vehicle to roll unimpeded by the resistance of the engine. This feature (block 210) may be initially disabled and enabled once some of the above criteria have been satisfied. Likewise, once it is enabled, if further evaluation indicates that the feature (block 210) is being inappropriately used, it can be removed from the list of features or routines for which the transmission is enabled. In some cases, it is desirable for the free-wheeling function (block 210) to allow the engine to overspeed. This might be allowed to occur if some of the above criteria have been satisfied, especially those related to the appropriate use of the free-wheeling mode of operation (block 210).

Another routine that can be enabled or modified based upon defined criteria is an idle driving feature of the transmission (block 212). The transmission in idle driving mode (block 212) allows the engine to operate at idle speed and still propel the vehicle. This is especially useful for situations in which the vehicle is moving at low speeds. Furthermore, idle driving can additionally feature a bump-shifting function (block 214) wherein a slight depression of the accelerator or brake pedal while in the mode causes the transmission to upshift or downshift.

The engine, like the transmission, can be adjusted when certain predetermined criteria have been met. The examples, also shown in FIG. 2C, described below are provided for illustrative purposes only and one of ordinary skill might modify or appreciate different features. As presented herein, the features can be described as engine limitations (block 160), idle adjustments and driver display functions. Many engine limitations can be set at predetermined limits either by the vehicle owner, manufacturer or others authorized to make such adjustments. In response to appropriate driver behavior as indicated by the above mentioned measured characteristics, the engine may be allowed to have increased horsepower (block 260), torque (block 262), maximum engine speed (block 264), and better response (block 266). These may be added incrementally to a series of predetermined thresholds or set to maximum designed parameters, at once. If there is a series, a continued set of measured criteria results in awarding the driver even more features or functionalities. The engine can also be enabled to respond more rapidly to a depression of the accelerator pedal to produce the desired vehicle acceleration. Like the above described features, the response time can either be to a predetermined maximum value, or via a series of steps.

Engine idle operation can be modified to include specific additional features such as adjusting the idle speed (block 270), increasing the time allowed before the engine shuts down after idle operation has began (block 268), and reducing the noise produced by the engine in idle mode (block 272). The idle speed of the engine is preferably set at a particular idle speed, but in some circumstances it is desired that the engine operate at higher engine speeds than the preset idle speed. Often, the engine is set such that after a predetermined period of idle operation, the engine will shutdown. Under certain circumstances this is not desirable and when the above criteria have been satisfied, it is possible to extend the predetermined idle time of the engine. Likewise, special injection techniques and the like can be used to decrease the engine noise during idle operation. By reducing the noise during idle operation, driver comfort can be increased.

Further, the driver can be made aware of these new enhanced features through the driver display (block 274). The display could indicate for example the driver's performance in relation to some of the above specified criteria as well as indicate to the driver the new horsepower, torque, and engine speed limitations.

In order to provide the driver with the features to which he/she has already gained access, the heavy vehicle can be provided with a way to determine the identity of an entering driver. In some instances, the vehicle obtains driver information through the use of a smart card or other identification badge. Alternatively, the heavy vehicle can obtain driver information through a built-in identification device which could include a password or biometric identifier. Additionally, the heavy vehicle could monitor some of the above criteria over a predetermined period of time and monitor behaviors to determine, who the likely driver is and what types of features should be enabled for that particular driver.

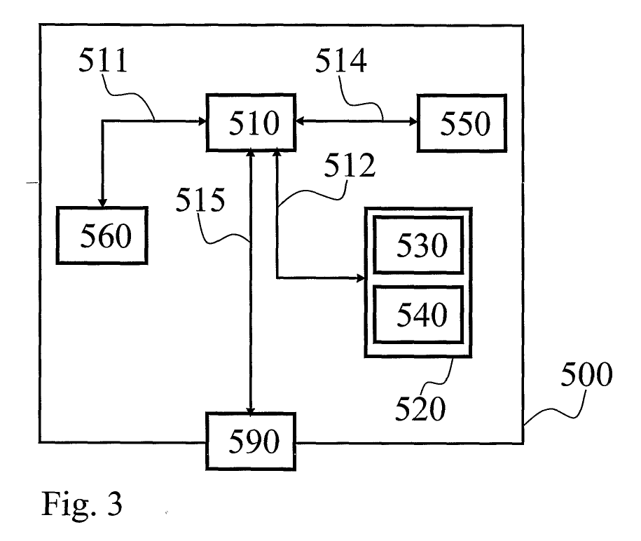

FIG. 3 shows an apparatus 500 according to one embodiment of the invention, comprising a nonvolatile memory 520, a processor 510 and a read and write memory 560. The memory 520 has a first memory part 530, in which a computer program for controlling the apparatus 500 is stored. The computer program in the memory part 530 for controlling the apparatus 500 can be an operating system.

The apparatus 500 can be enclosed in, for example, a controller, such as the transmission controller or a engine controller. The data-processing unit 510 can comprise, for example, a microcomputer.

The memory 520 also has a second memory part 540, in which a program for adapting an AMT according to the invention is stored. In an alternative embodiment, the program for adapting an AMT is stored in a separate nonvolatile data storage medium 550, such as, for example, a CD or an exchangeable semiconductor memory. The program can be stored in an executable form or in a compressed state.

When it is stated below that the data-processing unit 510 runs a specific function, it should be clear that the data-processing unit 510 is running a specific part of the program stored in the memory 540 or a specific part of the program stored in the nonvolatile recording medium 550.

The data-processing unit 510 is tailored for communication with the memory 550 through a data bus 514. The data-processing unit 510 is also tailored for communication with the memory 520 through a data bus 512. In addition, the data-processing unit 510 is tailored for communication with the memory 560 through a data bus 511. The data-processing unit 510 is also tailored for communication with a data port 590 by the use of a data bus 515.

The method according to the present invention can be executed by the data-processing unit 510, by the data-processing unit 510 running the program stored in the memory 540 or the program stored in the nonvolatile recording medium 550.

The invention should not be deemed to be limited to the embodiments described above, but rather a number of further variants and modifications are conceivable within the scope of the following patent claims.

1. A method for adapting an automatic mechanical transmission (AMT) on a heavy vehicle, the method comprising:
assessing at least one driving characteristic of an operator of the vehicle;
classifying the operator based on the assessment as being one of:
entitled to enhanced transmission features, and
not entitled to enhanced transmission features; and
enabling at least one enhanced transmission feature for the operator if classified as being entitled to enhanced transmission features.

2. The method as recited in claim 1, further comprising:
maintaining current transmission features for the operator if classified as not being entitled to enhanced transmission features.

3. The method as recited in claim 1, further comprising:
reducing current transmission features for the operator if classified as not being entitled to enhanced transmission features.

4. The method as recited in claim 1, further comprising:
reducing current transmission features for the operator if assessed to have sub-par driving characteristics.

5. The method as recited in claim 1, wherein the at least one driving characteristic of the operator of the vehicle comprises at least one of a measurable transmission-related characteristic and a measurable engine-related characteristic.

6. The method as recited in claim 5, wherein the at least one driving characteristic of the operator of the vehicle comprises at least one measurable transmission-related characteristic.

7. The method as recited in claim 6, wherein the at least one measurable transmission-related characteristic of the operator of the vehicle comprises at least one of the following:
a) proficiency of operator selection of economy mode driving;
b) proficiency of operator selection of free-wheeling mode driving;
c) proficiency of start gear selection; and
d) proficiency of operator utilization of braking programs.

8. The method as recited in claim 6, wherein the at least one measurable transmission-related characteristic of the operator of the vehicle comprises proficiency of operator selection of economy mode driving.

9. The method as recited in claim 6, wherein the at least one measurable transmission-related characteristic of the operator of the vehicle comprises proficiency of operator selection of free-wheeling mode driving.

10. The method as recited in claim 6, wherein the at least one measurable transmission-related characteristic of the operator of the vehicle comprises proficiency of start gear selection.

11. The method as recited in claim 6, wherein the at least one measurable transmission-related characteristic of the operator of the vehicle comprises proficiency of operator utilization of braking programs.

12. The method as recited in claim 5, wherein the at least one driving characteristic of the operator of the vehicle comprises operator proficiency at switching between brake and accelerator actuation.

13. The method as recited in claim 5, wherein the at least one driving characteristic of the operator of the vehicle comprises operator proficiency at clutch utilization.

14. The method as recited in claim 5, wherein the at least one driving characteristic of the operator of the vehicle comprises operator proficiency at accelerator utilization.

15. The method as recited in claim 5, wherein the at least one driving characteristic of the operator of the vehicle comprises operator proficiency at cruise control utilization.

16. The method as recited in claim 5, wherein the at least one driving characteristic of the operator of the vehicle comprises operator proficiency at engine warm-up utilization.

17. The method as recited in claim 5, wherein the at least one driving characteristic of the operator of the vehicle comprises operator proficiency at engine cool-down utilization.

18. The method as recited in claim 5, wherein the at least one driving characteristic of the operator of the vehicle comprises operator proficiency at affecting regeneration of a regenerative diesel particulate filter.

19. The method as recited in claim 6, wherein the at least one enhanced transmission feature that is enabled is at least one of the following:
a) kickdown;
b) skip shifting;
c) manual mode shifting;
d) auxiliary brake enabled mode;
e) free-wheeling mode;
f) idle driving; and
g) bump-shifting in idle drive mode.

20. The method as recited in claim 19, wherein the at least one enhanced transmission feature that is enabled is kickdown.

21. The method as recited in claim 19, wherein the at least one enhanced transmission feature that is enabled is skip shifting.

22. The method as recited in claim 19, wherein the at least one enhanced transmission feature that is enabled is manual mode shifting.

23. The method as recited in claim 19, wherein the at least one enhanced transmission feature that is enabled is auxiliary brake enabled mode.

24. The method as recited in claim 19, wherein the at least one enhanced transmission feature that is enabled is free-wheeling mode.

25. The method as recited in claim 19, wherein the at least one enhanced transmission feature that is enabled is idle driving.

26. The method as recited in claim 19, wherein the at least one enhanced transmission feature that is enabled is bump-shifting in idle drive mode.

27. The method as recited in claim 1, further comprising:
classifying the operator based on the assessment as being one of:
entitled to enhanced engine features, and
not entitled to enhanced engine features; and
enabling at least one enhanced engine feature for the operator if classified as being entitled to enhanced engine features.

28. The method as recited in claim 27, wherein the at least one enhanced engine feature that is enabled is at least one of the following:
a) increased maximum horsepower output;
b) increased maximum torque output;
c) increased maximum engine speed; and
d) enhanced engine responsiveness.

29. The method as recited in claim 28, wherein the at least one enhanced engine feature that is enabled is increased maximum horsepower output.

30. The method as recited in claim 28, wherein the at least one enhanced engine feature that is enabled is increased maximum torque output.

31. The method as recited in claim 28, wherein the at least one enhanced engine feature that is enabled is increased maximum engine speed.

32. The method as recited in claim 28, wherein the at least one enhanced engine feature that is enabled is enhanced engine responsiveness.

33. A computer program comprising a program code for executing the method as claimed in claim 1, when the computer program is executed on a computer.

34. A computer program product comprising a program code, stored on a computer-readable medium, for executing the method as claimed in claim 1, when the computer program is executed on the computer.

35. A computer program product directly loadable into an internal memory in a computer, which computer program product comprises a computer program for executing the method as claimed in claim 1, when the computer program on the computer program product is executed on the computer.
